(19) United States
(12) Patent Application Publication
(10) Pub. No.: US 2008/0270818 A1
(43) Pub. Date: Oct. 30, 2008

(54) Serial Communication Interface with Low Clock Skew

(75) Inventor: Geertjan Joordens, Sunnyvale, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/089,251

(22) PCT Filed: Oct. 9, 2006
(86) PCT No.: PCT/IB06/53698

§ 371 Date: Apr. 4, 2008

(30) Foreign Application Priority Data
Oct. 11, 2005 (US) 60/725906
Dec. 15, 2005 (US) 60/751114

(51) Int. Cl. G06F 1/04

(52) U.S. Cl. 713/500

(57) ABSTRACT

A communication interface for use in an integrated circuit comprises a clock root circuit (110) configured to receive the clock reference signal and to generate a clock tree signal. A first lane circuit (220b) is coupled to the clock root circuit and configured to receive the clock tree signal and a select signal for selecting a clock signal for a first interface circuit. A second lane circuit (220a) is coupled to the first lane circuit and configured to receive the clock tree signal and a select signal for selecting a clock signal for a second interface circuit. In one embodiment, each lane circuit includes a buffer (222) configured to receive the clock tree signal and a multiplexer (228) configured to selectively deliver the clock tree signal to the interface circuit. Advantages of the invention include a modular construction of a communication interface having low clock skew.

The present invention relates to the general field of serial communications interfaces for integrated circuits. With the incorporation of multiple lanes of interfaces on an integrated circuit, it is useful to minimize clock skew between among the lanes.

Serial communication interfaces are well known in the field of integrated circuit design. The Physical Layer (PHY) of a serial interface generally includes a Phase Locked Loop (PLL) and a number of serializer-deserializer (SerDes) blocks (one per lane). The PLL generates a high frequency clock from a clean reference (e.g. a crystal). The clock is distributed to each of the SerDes blocks that use the clock to recover and deserialize incoming data and serialize and transmit outgoing data. The clock frequency is usually very high, and often higher than 1 GHz. For example a PCI Express communication interface requires a 2.5 GHz clock in order to transmit a 2.5 Gb/s data stream per lane.

One of the problems for PHY designers is how to distribute the clock from the PLL to the SerDes blocks. Any jitter added by the clock routing is visible at the data output of the PHY, and most communication protocol specifications do not tolerate much jitter. Therefore it is important to carefully design and construct a clock distribution network for the PHY interface.

Clock distribution in a single-lane PHY is not a problem. The PLL and SerDes can be put together very closely. Even a two-lane configuration is fairly simple, as the PLL can be constructed between the two SerDes blocks.

Clock distribution and jitter problems tend to arise when designing more than two lanes. As communication ports on integrated circuits become more numerous, designers are required to construct physical layers with more than two lanes, and sometimes even more than four lanes. For example, the PCI Express specification allows up to 32 lanes, each running at 2.5 Gb/s, and the skew between the lanes must be kept as low a possible. The more lanes amplifies the difficulty of distributing the clock to all the lanes while minimizing clock skew.

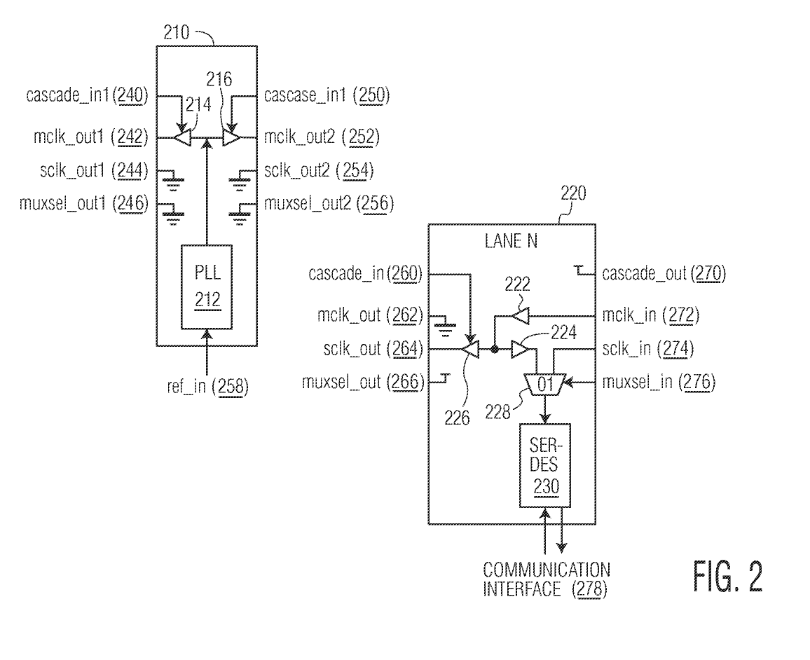

FIG. 2 depicts a conventional PHY interface designed as a clock tree, which distributes the clock signal to the lanes 120a-120d in a consecutive manner. The most optimum position for the PLL 110 is in the middle with two lanes on each side. The problem is how to distribute the clock to the four SerDes lanes in the most efficient manner and with the least clock skew. FIG. 2 depicts the conventional solution of building a delay line as part of a SerDes lane and propagating the clock sequentially to each lane.

The problem with this design is that it creates clock skew between the different lanes. The SerDes blocks 120b and 120c receive an early clock and the SerDes blocks 120a and 120d receive a late clock delayed by buffers in blocks 120b and 120c, respectively. This buffer delay may cause the clock skew to be out of tolerance for many applications.

What is needed is an improved technique for distributing clock signals to multiple SerDes lanes while ensuring minimal clock skew between the lanes.

The invention employs a modular technique to distribute clock signals to one or more lanes while ensuring minimal clock skew between the lanes. Each lane module is connected to other modules to construct multiple SerDes lanes. Several exemplary embodiments are provided to demonstration the invention.

An exemplary embodiment a communication interface for use in an integrated circuit comprises a clock root circuit configured to receive the clock reference signal and to generate a clock tree signal. A first lane circuit is coupled to the clock root circuit and configured to receive the clock tree signal and a select signal for selecting a clock signal for a first interface circuit. A second lane circuit is coupled to the first lane circuit and configured to receive the clock tree signal and a select signal for selecting a clock signal for a second interface circuit.

In one embodiment, each lane circuit includes a buffer configured to receive the clock tree signal and a multiplexer configured to selectively deliver the clock tree signal to the interface circuit.

Advantages of the invention include a modular construction of a communication interface having low clock skew. Another advantage is the modular approach of the invention permits a designer to construct any number of SedDes lanes with only a few building blocks. The clock is then automatically distributed through the cascadable clock tree with very little clock skew between the lanes.

The invention is described with reference to the following figures.

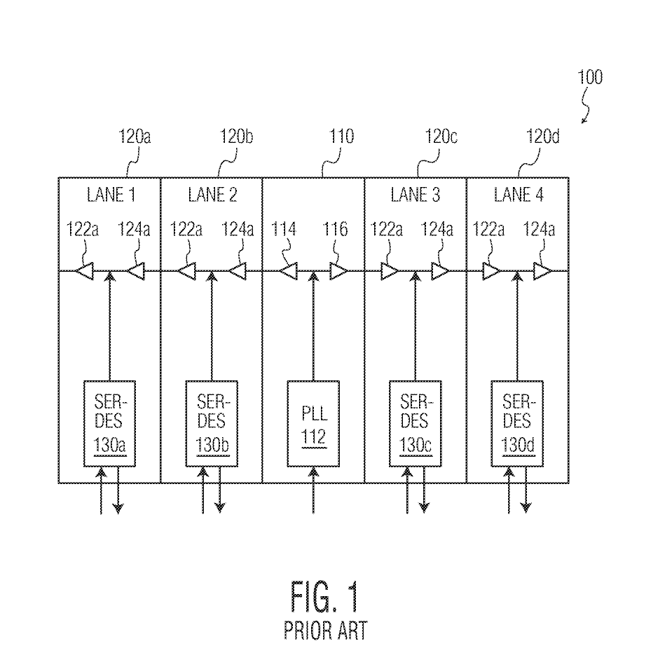

FIG. 1 depicts a conventional serial interface.

FIG. 2 depicts modular components for constructing a serial interface according to an embodiment of the invention.

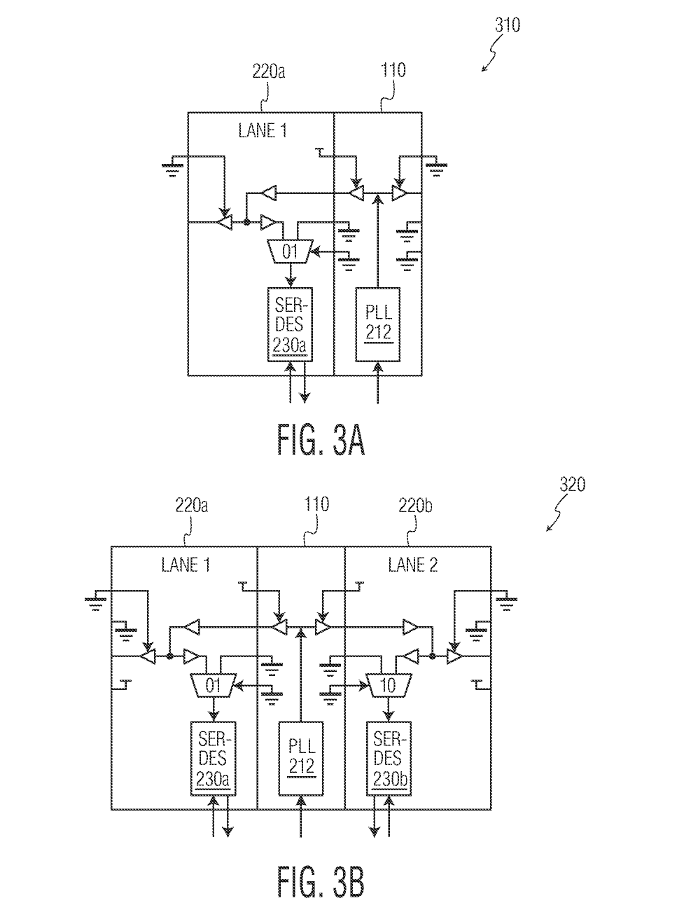

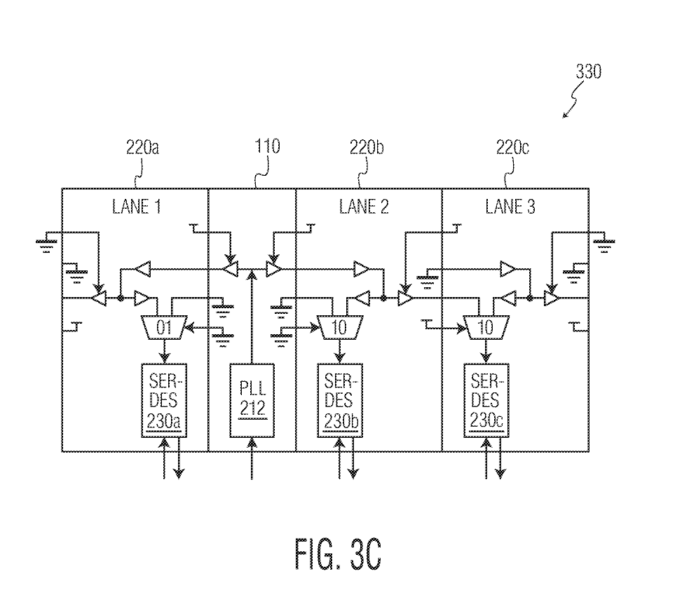

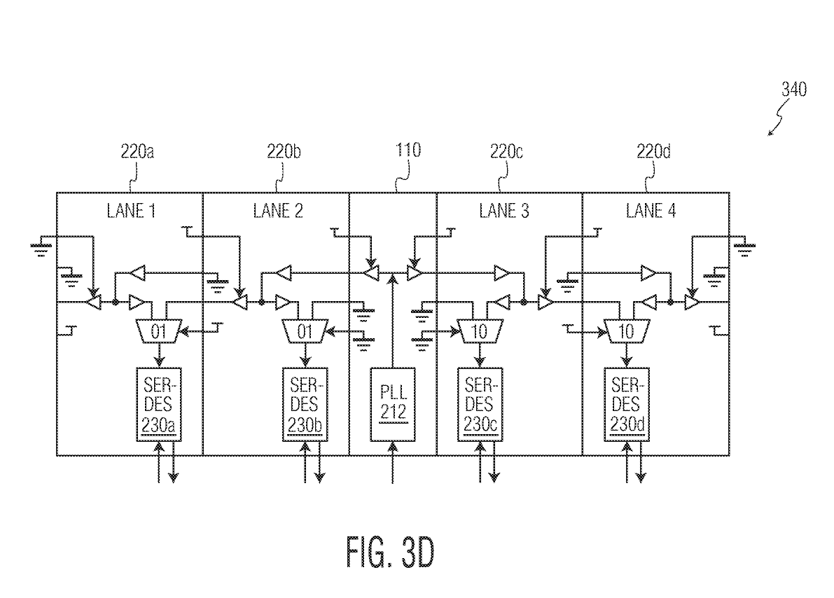

FIGS. 3A-D depict serial interfaces employing modular components according to embodiments of the invention.

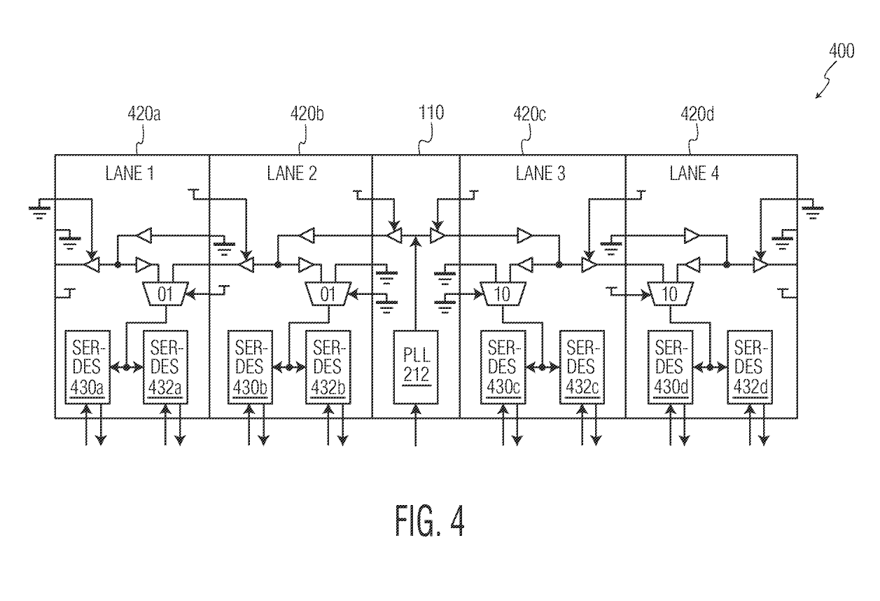

FIG. 4 depicts a serial interface employing modular components according to an embodiment of the invention.

The invention is described with reference to specific apparatus and embodiments. Those skilled in the art will recognize that the description is for illustration and to provide the best mode of practicing the invention.

One exemplary aspect of the invention is that a Physical Layer (PHY) of a serial-deserial (SerDes) interface can be constructed from modular components. This is advantageous because it permits quick and reliable construction when designing a PHY interface for an integrated circuit. In one aspect, the modules are macro components that are used when designing interfaces for integrated circuits, which helps designers construct integrated circuits using computer aided design tools. With the modular components, the clock distribution is part of the PHY design, so it can be part of a macro.

FIG. 2 depicts modular components for constructing a serial interface according to an embodiment of the invention. A clock distribution root circuit 210 includes a Phase Locked Loop (PLL) 212 and buffer circuits 214 and 216 to distribute the clock signal to the lanes. An exemplary lane 220 includes an input buffer circuit 222 and buffer circuits 224 and 226 to distribute the clock signal. Buffer 222 is included in the exemplary embodiment to show the best mode of constructing the invention, since the buffer can be useful to buffer up the clock to ensure sufficient signal drive to buffers 224 and 226. One alternate embodiment of the invention is constructed without buffer 222 by using a wire in place. Buffer 224 is coupled to a multiplexer 228 that communicates the clock signal to the SerDes circuit 230. In operation, the multiplexer passes the signal adjacent the 0 indicia in response to ground (logic level 0) and the signal adjacent the 1 indicia in response to power (logic level 1). Since the components are designed to be cascaded by placing them next to one another, there are a number of inputs and outputs to each stage of the cascade, which are described below. These signals are described with respect to signals and terminals for communicating the signals to each of the components.

cascade_in1 (240) is the cascade input for the clock root circuit buffer 214.

mclk_out1 (242) is the master clock output for lanes to the left of the clock root circuit.

sclk_out1 (244) is the select clock output for adjacent lanes to the left of the clock root circuit.

muxsel_out1 (246) is the multiplexer select signal output for adjacent lanes to the left of the clock root circuit.

cascade_in1 (250) is the cascade input for the clock root circuit buffer 216.

mclk_out2 (252) is the master clock output for lanes to the right of the clock root circuit.

sclk_out2 (254) is the select clock output for adjacent lanes to the right of the clock root circuit.

muxsel_out2 (256) is the multiplexer select signal output for adjacent lanes to the right of the clock root circuit.

ref_in (258) is the input for the reference clock, e.g., a crystal.

cascade_in (260) is an input to receive power from an adjacent lane or is terminated by being connected to ground.

mclk_out signal (262) is an output to an adjacent lane connected to ground.

sclk_out (264) is an output to send a clock signal to an adjacent lane.

muxsel_out (266) is the multiplexer select signal output for an adjacent lane to the left of the exemplary lane circuit.

cascade_out (270) is a power signal for adjacent lanes to the right of the exemplary lane circuit.

mclk_in (272) is an input clock signal from the clock distribution root circuit.

sclk_in (274) is an input clock signal from an adjacent lane to the right of the exemplary lane.

muxsel_in (276) is an input multiplexer select signal from the right of the exemplary lane.

communication interface (278) is the PHY communication interface for the lane.

FIGS. 3A-D depict serial interfaces employing modular components according to embodiments of the invention. These embodiments show a clock distribution network where the clocks delivered to the lanes are at the same depth; that is the clocks are driven through the same number of buffers to arrive at each of the SerDes circuits. This ensures very little clock skew between the clocks delivered to the circuits and promotes compliance with communication protocols that may have very little skew tolerance.

FIG. 3A depicts a single lane SerDes according to an embodiment of the invention. Clock distribution root circuit 110 is coupled to lane 220a and supplies the lane with the clock signal (mclk) and other signals necessary to deliver the proper clock signal to the SerDes 230a. The clock distribution root circuit provides a ground signal to the multiplexer input to select the clock signal input adjacent to the 0 indicia. The lane 220 also receives a termination signal ground input to the cascade_in (260) input. Proper termination of the lanes ensures proper operation of the circuits and reduces any induced noise.

FIG. 3B depicts a single lane SerDes according to an embodiment of the invention. Lanes 220a and 220 are mirror images of one another. Clock distribution root circuit 110 is coupled to lanes 220a and 220b, and supplies the lanes with the clock signal (mclk) and other signals necessary to deliver the proper clock signal to the SerDes 230a and 230b, respectively. The clock distribution root circuit provides a ground signal to the multiplexer input to select the clock signal input adjacent to the 0 indicia. The lanes 220a and 220b also receive a termination signal ground input to the cascade_in (260) input. Proper termination of the lanes ensures proper operation of the circuits and prevents unloaded buffers and spikes on the power supply.

FIG. 3C depicts a single lane SerDes according to an embodiment of the invention. Clock distribution root circuit 110 is coupled to lanes 220a and 220b, and supplies the lanes with the clock signal (mclk) and other signals necessary to deliver the proper clock signal to the SerDes 230a and 230b, respectively. The clock distribution root circuit provides a ground signal to the multiplexer input to select the clock signal input adjacent to the 0 indicia. The additional lane 220c receives signals from lane 220b including the muxsel_in (276) signal that causes the multiplexer to select the proper clock signal adjacent to the 1 indicia. The lanes 220a and 220c also receive a termination signal ground input to the cascade_in (260) input. Lane 220b receives a signal from lane 220c that powers buffer 226 to generate the sclk_out (264) signal for lance 220c input to sclk_in (274). Proper termination of the lanes ensures proper operation of the circuits and prevents unloaded buffers and spikes on the power supply.

FIG. 3D depicts a single lane SerDes according to an embodiment of the invention. This embodiment is similar to that shown in FIG. 3C and includes an additional lane so that four lanes are depicted.

In some cases, it may be desirable to have more than four SerDes circuits. FIG. 4 depicts a serial interface employing modular components according to an embodiment of the invention. This embodiment adds an additional SerDes circuit 432 to each of the lanes so that there is collectively up to eight SerDes circuits. Naturally, this embodiment can be constructed in a similar manner to that shown in FIGS. 3A-D or variations thereof to achieve any desired number of SerDes circuits. Furthermore, it is anticipates to split the cells further up to build a PHY having 16, 32 or even more SerDes lanes.

As can be seen with reference to the drawings and description, the clock distribution network described herein provides all SerDes circuits with a clock signal that is evenly distributed. The buffer circuits shown in the exemplary embodiments provide the clock tree having an equal delay for all lanes. The only skew between the lane clocks is skew due to mismatch of the buffers and routing, which is usually very small. Consequently, the SerDes lanes will have very little clock skew with respect to one another.

The invention can be used in any serial interface. Even if the interface has only one lane, the invention allows sharing of the clock by two or more of the interfaces, thereby saving power and area.

Exemplary serial interfaces in which the invention can be applied include: PCI Express; Serial-ATA; MIPI; USB; IEEE 1394; XAUI; Hyper Transport; Rapid IO; Sonet; Ethernet and others. The invention may also be used in a non-standard or proprietary serial interface.

The invention has numerous advantages. The invention provides a clock distribution tree ensuring low clock skew among a plurality of lanes. This promotes reliable communication with the circuit under protocol specifications. The invention is modular and promotes efficient placement and routing when designing integrated circuit interfaces. The result is a benefit to both the designed, manufacturer and user of the integrated circuit employing the invention.

Having disclosed exemplary embodiments and the best mode, modifications and variations may be made to the disclosed embodiments while remaining within the subject and spirit of the invention as defined by the following claims.

1. A communication interface for use in an integrated circuit comprising:
a clock root circuit configured to receive the clock reference signal and to generate a clock tree signal;
a first lane circuit coupled to the clock root circuit and configured to receive the clock tree signal and a select signal for selecting a clock signal for an interface circuit;
and a second lane circuit coupled to the first lane circuit and configured to receive the clock tree signal and a select signal for selecting a clock signal for an interface circuit.

2. The communication interface of claim 1, wherein: the first lane circuit is coupled adjacent to the clock root circuit; and the second lane circuit is coupled adjacent to the first lane circuit.

3. The communication interface of claim 2, further comprising:
a third lane circuit coupled to the clock root circuit and configured to receive the clock tree signal and a select signal for selecting a clock signal for an interface circuit;
and a fourth lane circuit coupled to the third lane circuit and configured to receive the clock tree signal and a select signal for selecting a clock signal for an interface circuit; wherein the first lane circuit is coupled adjacent to the clock root circuit; and wherein the second lane circuit is coupled adjacent to the first lane circuit.

4. The communication interface of claim 1, wherein: the first lane circuit and second lane circuit are identical in construction.

5. The communication interface of claim 3, wherein: the first lane circuit and second lane circuit are identical in construction; and the third lane circuit and fourth lane circuit are identical in construction.

6. The communication interface of claim 1, wherein: each lane circuit includes a buffer configured to receive the clock tree signal and a multiplexer configured to selectively deliver the clock tree signal to the interface circuit.

7. The communication interface of claim 3, wherein: each lane circuit includes a buffer configured to receive the clock tree signal and a multiplexer configured to selectively deliver the clock tree signal to the interface circuit.

8. A lane circuit for use in a communication interface comprising:
a first clock tree terminal adapted to receive a first clock tree signal;
a second clock tree terminal adapted to receive a second clock tree signal;
a select terminal adapted to receive a select signal;
and a multiplexer coupled to the first clock tree terminal, the second clock tree terminal and the select terminal, responsive to the select signal for selecting a clock tree signal from one of the first clock tree terminal and the second clock tree terminal.

9. The lane circuit of claim 8, further comprising: an output clock terminal.

10. The lane circuit of claim 9, further comprising: two buffers disposed between the first clock tree terminal and the multiplexer; and two buffers disposed between the first clock tree terminal and the output clock tree terminal.

11. The lane circuit of claim 10, wherein: one of the two buffers is a common buffer.

12. The lane circuit of claim 10, wherein: there is no buffer disposed between the second clock tree terminal and the multiplexer.

13. A method of generating a clock tree for use in a communication interface comprising the steps of:
receiving a clock reference signal;
generating a clock tree signal and a first select signal;
receiving the clock tree signal and the first select signal in a first lane, the first select signal for selecting a clock signal for an interface circuit;
propagating the clock tree signal to a second lane and generating a second select signal;
and receiving the clock tree signal and the second select signal in a second lane, the second select signal for selecting a clock signal for an interface circuit.

14. The method of claim 13, further comprising the step of: selecting the clock tree signal in the first lane based on the first select signal; and selecting the clock tree signal in the second lane based on the second select signal.

15. The method of claim 13, further comprising the step of: receiving the clock tree signal and a third select signal in a third lane, the third select signal for selecting a clock signal for an interface circuit; propagating the clock tree signal to a fourth lane and generating a fourth select signal; receiving the clock tree signal and the fourth select signal in a fourth lane, the fourth select signal for selecting a clock signal for an interface circuit.

16. The method of claim 15, wherein the first select signal and the third select signal are the same signal.
